(19) United States
(12) Patent Application Publication
(10) Pub. No.: US 2006/0228614 A1
(43) Pub. Date: Oct. 12, 2006

(54) Assembly structure of clustering fuel cell

(76) Inventors: Hsi-Ming Shu, Taipei (TW); Feng-Yi Deng, Taipei (TW); Tsang-Ming Chang, Taipei (TW)

Correspondence Address: G .LINK Co.,LTD, 3550 Bell Road,, MINOOKA, IL, 60447, US

(21) Appl. No.: 11/102,231

(22) Filed: Apr. 11, 2005

(51) Int. Cl. H01M 8/02; H01M 8/10; H01M 8/04; H01M 8/24

(52) U.S. Cl. 429/38; 429/22; 429/32

(57) ABSTRACT

The present utility is related to an assembly structure of clustering fuel cell, comprising the fuel cell, electrical plug board and fuel control unit. The fuel cell has a PCB substrate, at least more than one membrane electrode assembly (MEA), fuel injecting inlet and electrically connecting part. The electrical plug board includes at least more than one electrical connector; each electrical connector is used to plug into the electrically connecting part of each fuel cell. The fuel control unit includes at least more than one fuel output outlet, wherein each fuel output outlet contacts with the fuel injecting inlet of each fuel cell.

### FIELD OF THE INVENTION

The present utility is related to a fuel cell, especially to an assembly structure of clustering fuel cell.

### BACKGROUND OF THE INVENTION

The conventional fuel cell is limited by self structure, for instance, the used direct methanol fuel cell desiring to increase the power output has to change the internal structure by increasing the amount of membrane electrode assemblies (MEAs) of the direct methanol fuel cell and also change other related constitutions like the field in accordance. As a result, there are major disadvantages of huge changes due to little modification.

Another way is to connect in serial and parallel the positive and negative electrodes of each individual used fuel cell. It is possible to increase the total power output, however, each individual used fuel cell has its original constitution like the fuel tank and therefore the total volume of combining all fuel cells in serial and parallel connections being significantly enormous is the major disadvantage.

The inventor investigates the disadvantages of the used fuel cell and desires to improve and invent an assembly structure of a fuel cell to easily implement light, thin, short, small and high power output.

### SUMMARY OF THE INVENTION

The first object of the present invention is to provide an assembly structure of the fuel cell to easily implement light, thin, short, small and high power output.

The second object of the present invention is to provide a fuel cell of clustering multiple assembly.

The third object of the present invention is to provide an assembly structure to easily repair and plug or change in order to cluster multiple assemble each fuel cell.

To achieve the above objects, the present utility provides an assembly structure of a clustering fuel cell, comprising: the fuel cell utilizing the print circuit board (PCB) process, comprising the PCB, at least more than one MEA placed upon the PCB, the fuel injecting inlet placed upon the PCB, the electrically connecting part placed upon the PCB and electrically connecting to the MEAs, the electrical plug board including at least more than one electrical connector wherein each electrical connector is used to plug into the electrically connecting part of each fuel cell, and the fuel control unit including at least more than one fuel output outlet wherein each fuel output outlet is contacted with the fuel injecting inlet of each fuel cell.

### BRIEF DESCRIPTION OF THE DRAWINGS

The above objects and advantages of the present invention will become more apparent with reference to the appended drawings wherein:

FIG. 1 shows the structural view of the present invention assembly structure of clustering fuel cell;

FIG. 2 shows the structural view of the present invention fuel cell;

FIG. 3 shows the structural view of the present invention electrical plug board; and

FIG. 4 shows the structural view of the present invention fuel control unit.

### DETAILED DESCRIPTION OF THE INVENTION

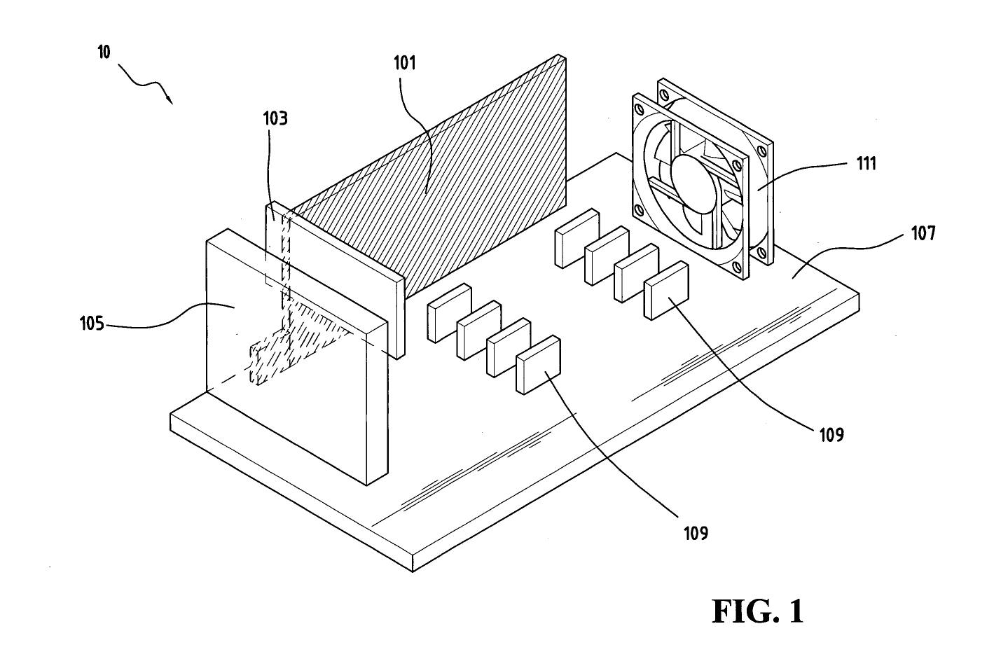

FIG. 1 shows the structural view of the present invention assembly structure of clustering fuel cell. The present invention assembly structure of clustering fuel cell 10 mainly comprises fuel cell 101, electrical plug board 103 and fuel control unit 105. In assembling the present invention clustering fuel cell, fuel cell 101 is plugged upon the substrate 107 and fixed by the fastened mechanism 109 placed on the substrate 107, and also fuel cell 101 connects to electrical plug board 103 and fuel control unit 105. The present invention assembly structure 10 is able to plug at least more than two fuels cell 101 and even when one fuel cell 101 in usage is damaged, the damaged fuel cell 101 is possible to be removed from assembly structure 10 and then re-plugs a new fuel cell 101. The fan 111 is placed on one side of the substrate 107, its major function is to adjust and control the heat temperature produced by the working fuel cell 101 and the air flux required for the reaction.

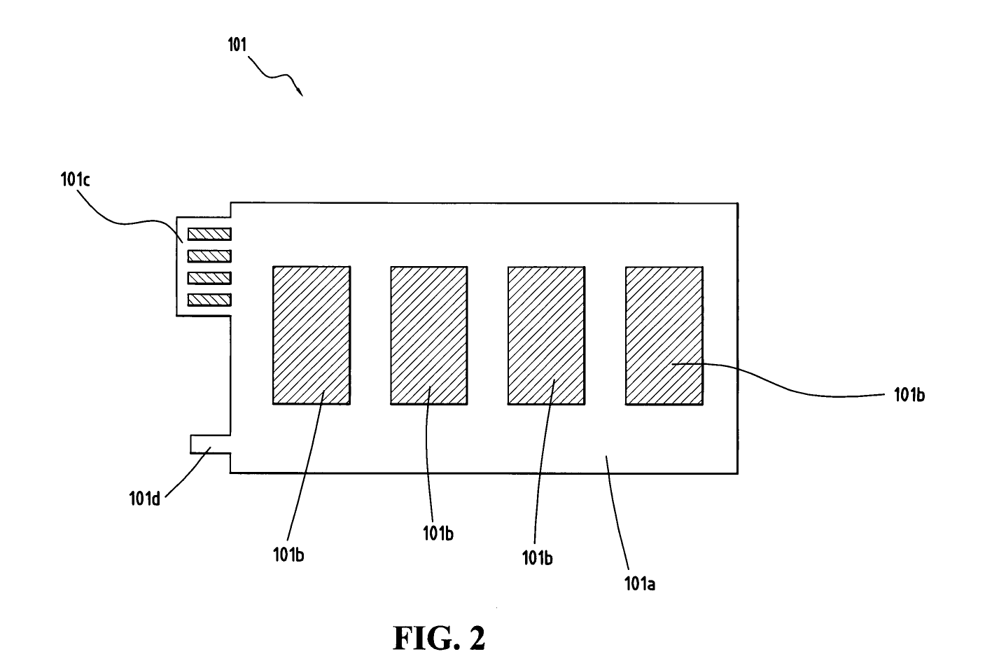

FIG. 2 shows the structural view of the present invention fuel cell. The fuel cell 101 used for the present utility is manufactured by the PCB process, it includes the PCB substrate 101a, at least more than one MEA 101b, electrically connecting part 101c and fuel injecting inlet 101d. These MEAs 101b, electrically connecting part 101c and fuel injecting inlet 101d are placed on the PCB substrate 101a. The present invention fuel cell 101 is capable of being the direct methanol fuel cell, the methanol fuel (not shown in FIG. 2) is injected from fuel injecting inlet 101d into the flow field (not shown in FIG. 2) in the PCB substrate 101a and flows toward each MEA 101b through the field. Electrically connecting part 101c is electrically connecting to each MEA 101b, especially connecting to the positive electrode and negative electrode of each MEA 101b, the concrete means of electrically connecting part 101c is possible to use golden fingers 101c which are directly formed on one side of the PCB substrate 101a.

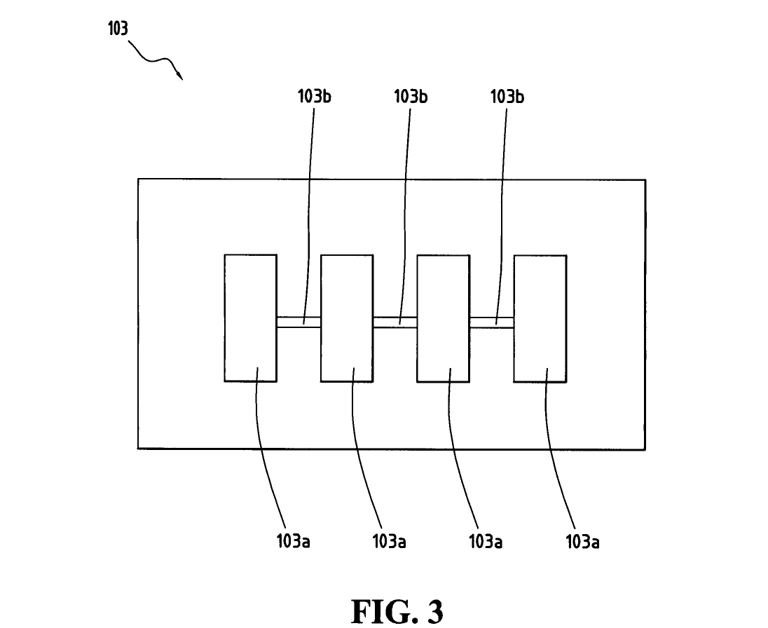

FIG. 3 shows the structural view of the present invention electrical plug board. Electrical plug board 103 is placed at least more than one electrical connector 103a, the amount of the placed electrical connector 103a depends on the capacity of plugging fuel cell 101 on assembly structure 10. The concrete means of electrical plug board 103 is possible to use the PCB and solders electrical connector 103a on the PCB like the female connector in order to make the golden fingers 101c electrically connected. Furthermore, the PCB has also placed the wires 103b, for instance, the wires 103b formed by etching copper foil of the PCB, to electrically connect to each electrical connector 103a.

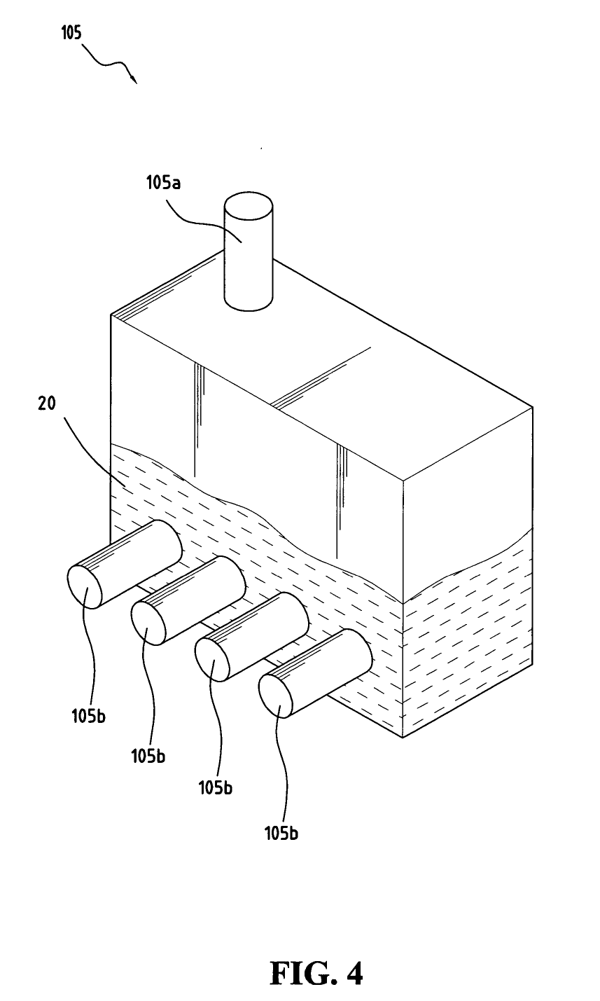

FIG. 4 shows the structural view of the present invention fuel control unit. Fuel control unit 105 is possible to be fixed on one side of the substrate 107 and has a hollow structure inside, and therefore the internal space is used to accommodate the fuel 20 like the liquid methanol fuel. Fuel control unit 105 is placed fuel injecting inlet 105a and above one fuel output outlet 105b. The fuel from the outside injects into the internal space of the fuel control unit 105 through injecting inlet 105a. The amount of fuel output outlets 105b similarly depends on the capacity of plugging fuel cell 101 on assembly structure 10. Fuel output outlet 105b is closely contacted with fuel injecting inlet 101d of fuel cell 101 and also the fuel 20 in fuel control unit 105 passes through each fuel output outlet 105b and finally injects into the interior of each fuel cell 101 from fuel injecting inlet 101d.

The above present invention substrate 107 is able to be manufactured by the metallic material or plastic molding. The concrete means of the fastened mechanisms 109 on the substrate 107 is possible to be the short rib, long rib strip or using the similar SIMM plug mechanism used for plugging the computer SIMM memory.

The present invention assembly structure of clustering fuel cell 10 is convenient to plug or withdraw fuel cell 101 so as to provide fuel cell 101 more convenience for the repair or changing components. Meanwhile, Assembly structure of clustering fuel cell 10 is easy to implement a fuel cell with light, thin, short, small and high power output.

Although the present utility has been disclosed one embodiment as the above, it does not imply to limit the present utility, any person who is skilled in the art could make any change or modification within the spirit and scope of the present utility, however, it belongs to the scope of the present utility, the protective scope of the present utility is defined by the following claims.

What is claimed is:

1. An assembly structure of clustering fuel cell, comprising:
a fuel cell utilizing the print circuit board (PCB) process, comprising:
a PCB substrate;
at least one membrane electrode assembly (MEA), placed on the PCB substrate;
a fuel injecting inlet, placed on the PCB substrate;
an electrically connecting part, placed on the PCB substrate and electrically connecting to the MEAs;
an electrical plug board, including at least one electrical connector, wherein each electrical connector is used to plug into the electrically connecting part of each fuel cell;
a fuel control unit includes at least one fuel output outlet, wherein each fuel output outlet is contacted with the fuel injecting inlet of each fuel cell.

2. The assembly structure of clustering fuel cell according to claim 1, further including a base wherein the fuel control unit is fixed on the base.

3. The assembly structure of clustering fuel cell according to claim 1, wherein the electrical connectors are mutually electrically connected.

4. The assembly structure of clustering fuel cell according to claim 1, wherein the electrically connecting part is golden fingers placed on the side of the PCB substrate.

5. The assembly structure of clustering fuel cell according to claim 1, wherein the MEAs are MEAs of a direct methanol fuel cell.

6. The assembly structure of clustering fuel cell according to claim 1, further including a fan.

7. The assembly structure of clustering fuel cell according to claim 2, wherein the base having at least one fastened mechanism and wherein each fastened mechanism fixes each fuel cell.
